(19) United States
(12) Patent Application Publication
(10) Pub. No.: US 2014/0301088 A1
(43) Pub. Date: Oct. 9, 2014

(54) LED DISPLAY SCREEN

(71) Applicants: Chen Lu, Shenzhen (CN); Danhu Cai, Shenzhen (CN); Linke Meng, Shenzhen (CN); Chudong Lu, Shenzhen (CN)

(72) Inventors: Chen Lu, Shenzhen (CN); Danhu Cai, Shenzhen (CN); Linke Meng, Shenzhen (CN); Chudong Lu, Shenzhen (CN)

(73) Assignee: RADIANT OPTO-ELEC TECHNOLOGY CO., LTD., Shenzhen, Guangdong (CN)

(21) Appl. No.: 13/985,049

(22) PCT Filed: May 31, 2013
(86) PCT No.: PCT/CN2013/076558

§ 371 Date: Aug. 13, 2013

(30) Foreign Application Priority Data
Apr. 8, 2013 (CN) 201310121728.5

(51) Int. Cl. F21K 99/00

(52) U.S. Cl. CPC F21K 9/30
USPC 362/382

(57) ABSTRACT

The present invention discloses a novel LED display screen. Equipped with a high power LED lamp and combining a high power lamp with a display screen. The LED display screen comprises a display module, a mounting framework, and a power distribution control box, characterized in that: said LED display module is equipped with a high power module. The display module and the power distribution control box are installed on a metal framework to form a display block. The power distribution control box is internally equipped with a drive power source, a signal receiving card, a signal transferring plate, a quick connector, etc. The mounting framework is equipped with a high-efficiency connector for quick coupling during installation of the display screen. The display screen in this scheme has a simple structure and a gorgeous display effect, is light, and is quickly and conveniently installed.

### BACKGROUND OF THE INVENTION

1. Technical Field

The present invention relates to the LED display field, specifically to an LED display capable of being assembled.

2. Description of Related Art

LED display screens are display products emitting light through LEDs, which are used for displaying images, characters, videos, etc., primarily used for displaying outdoor advertising media, background videos, and text messages for stages, etc. High power LED light can achieve a gorgeous light effect and can be used for generating a more beautiful and amazing effect for stage performance. Products combining light with display have not come into the market, yet. Among display screens for displaying the background of a stage, some are portable and quickly installable, but have a large outer frame and achieve a poor effect when assembling shaped screens.

### BRIEF SUMMARY OF THE INVENTION

To solve the above mentioned problems, the present invention aims to provide an LED product which combines light with display and can generate a more beautiful and amazing effect for stage performance, in particular to a display screen which has modules installed at an exquisite framework, can be quickly disassembled and assembled, and formed into different shapes.

To fulfill the technical aim, the present invention adopts the following scheme. An LED display screen is provided, wherein a display screen module consists of a small LED lamp, a printed circuit board and electronic components; the display screen module is also equipped with a high power LED lamp to form a display screen light module with displaying and lighting functions; and the display screen light module is installed on a framework and plugged into a power distribution control box which is installed on the framework.

Preferably, the display screen module is formed by welding the small LED lamp and electronic components on the printed circuit board and protected by a plastic housing.

Preferably, the framework consists of left and right pull rods and a fixed frame; a reinforcing plate is disposed in the middle of the framework; the upper part of each of the pull rods is provided with a U-shaped groove, while the lower part is provided with a plug matched with the U-shaped groove; a latch for connecting the upper and lower pull rods is disposed next to each U-shaped groove, and thus two blocks can be quickly connected in the vertical direction.

Preferably, the power distribution control box is made up of a metal bottom housing and a metal upper cover; the metal bottom housing is internally equipped with a drive power, a power output and signal transition plate and a signal output plate; a socket and a plug for quick connection of the power supply and signals are installed at two end of the metal bottom housing; and the metal upper cover is internally equipped with an adaptor plate.

Preferably, the high power LED lamp is installed in the housing with a heat dissipation function, and the lamp is externally covered with a condensing hood.

Preferably, the left and right pull rods of the framework are equipped with two groups of quick connectors for quick connection of left and right blocks, one used in the case that the display screen is flat and the other used in the case that modules are installed at an angle.

Preferably, the left and right pull rods of the framework are respectively equipped with a group of rotary handle for lifting the display screen.

Preferably, a waterproof rubber ring is located between the bottom housing and the upper cover and fastened with a screw.

Preferably, the DC power supply and signals of the drive power and the receiving card are transmitted to the adaptor plate by means of plugging.

Preferably, the quick connector for assembling the display screen modules into a panel consists of a slide fastener and a fastener base. The slide fastener is installed in a fixed seat and is capable of sliding and rotating left and right. The slide fastener rotates 90° after being aligned with the fastener socket and then is fixed together with the fastener base. The quick connector for installing the blocks at an angle consists of a pair of arced rings and a pair of fasteners. The arced rings are installed on a bracket and are capable of sliding on the bracket to adjust distance there-between and also capable of keeping the same radian. The two arced rings are connected together with the fasteners after the distance is adjusted.

The present invention has the following beneficial effects: Compared with the prior art, the LED display screen in the prior art has lighting and displaying two functions and therefore can generate a more beautiful and amazing effect. The display screen block adopts a portable mounting framework. The framework is provided with connection fasteners for assembling the display screen in a flat or an arced way, so that the display screen is easier to meet the user's demands.

### BRIEF DESCRIPTION OF THE SEVERAL VIEWS OF THE DRAWINGS

FIG. 1 is a structural view of the display screen block in the present invention;

FIG. 2 is a structural view of the display screen module in the present invention;

FIG. 3 is a structural view of the power distribution control box of the display screen in the present invention; and,

FIG. 4 is a structural view of the display screen framework in the present invention.

### DETAILED DESCRIPTION OF THE INVENTION

The present invention is described in further detail with reference to the attached drawings and the specific embodiments.

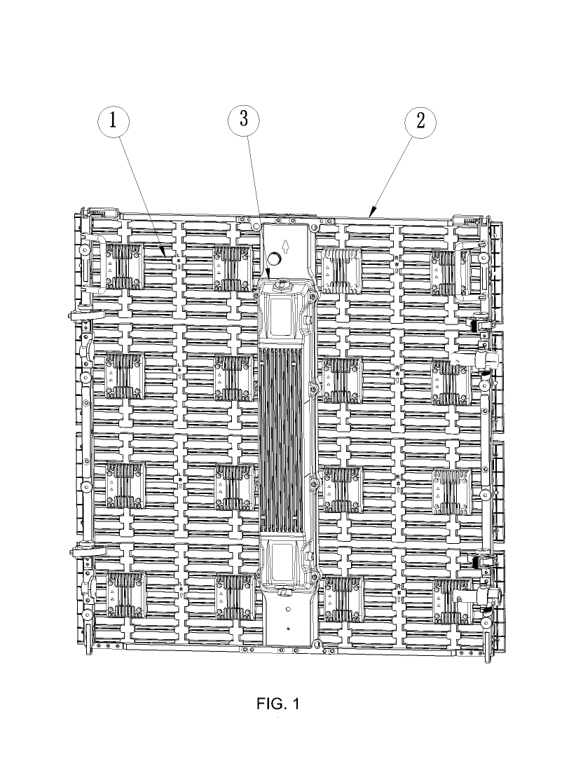

FIG. 1 shows a display screen in a specific embodiment of the present invention. The display screen comprises an LED lamp, a module 1 including related units, a fixed framework 2 consisting of a metal frame 21, pull rods 22, a reinforcing plate 23 and fasteners 24, and a power distribution control box 3 including a drive power 31, a metal housing 32, a receiving card 33, a rubber ring 34, quick connectors 35, etc. The module 1 and the power distribution control box 3 are installed on the framework 2. The framework 2 is smaller than the block in size.

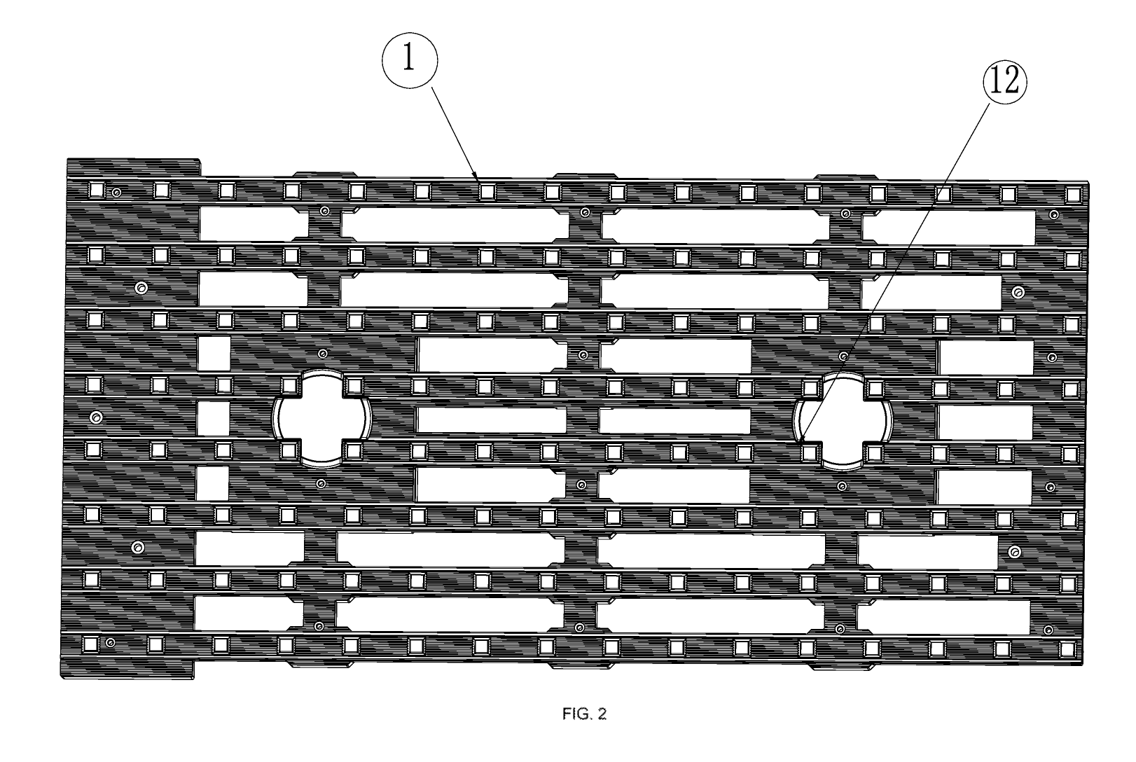

As shown in FIG. 2, the module 1 is equipped with a high power LED lamp 12.

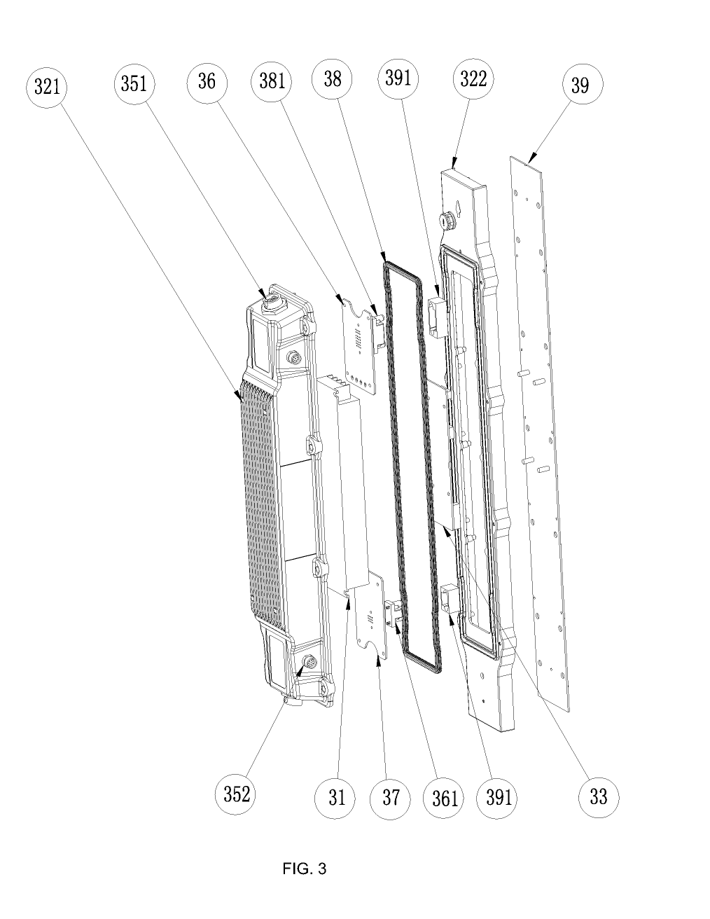

As shown in FIG. 3, the power distribution control box 3 consists of a metal bottom housing 321 and a metal upper cover 322. The bottom housing 321 is internally equipped with the drive power 31, and is equipped with a power supply signal transition plate 36 and a signal output plate 37 at two ends. The two ends of the bottom housing is equipped with a quick adaptor base 351 and a quick adaptor 352, and a waterproof rubber ring 38 are located between the bottom housing 321 and the upper cover 322. The upper cover 322 is internally equipped with an adaptor plate 39, and the receiving card 33 is fixed on the adaptor plate 39. The power supply signal transition plate 36 and the signal output plate 37 are equipped with a connector base 361. The adaptor plate 39 is equipped with an adaptor pin 391.

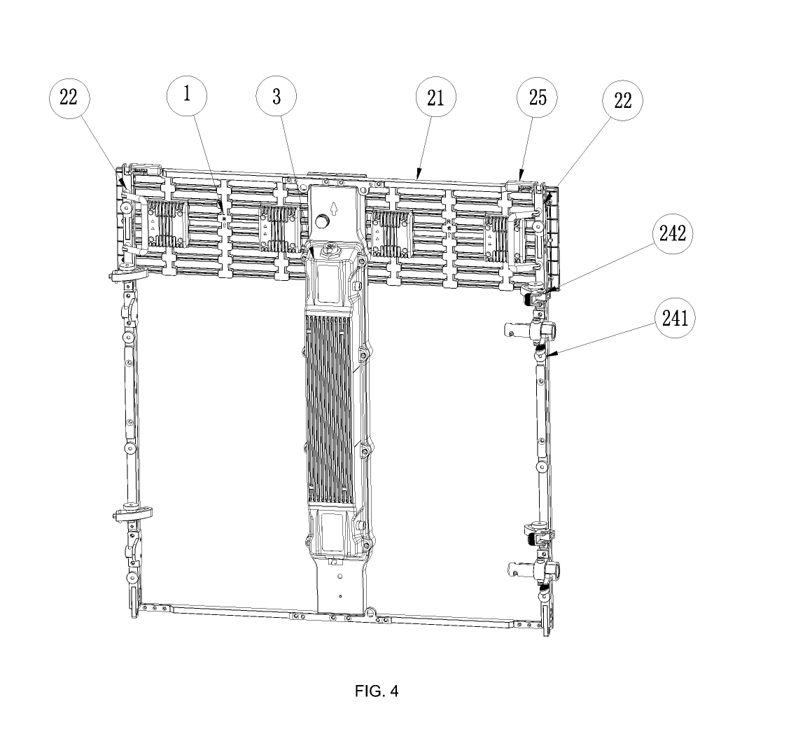

As shown in FIG. 4, the fixed framework 2 is used for installing the module 1 and the power distribution control box 3 and also used for connection between the display screen blocks and the suspended beam and connection between the blocks when the display screen is installed. The metal frame 21 of the fixed framework is equipped with two pull rods 22. One end of each of the pull rods 22 is a U-shaped groove and equipped with a slidable latch 25, while the other end is a plug matched with the U-shaped groove. The pull rods are equipped with two groups of fasteners 241 and fasteners 242 for different purposes. The fasteners 241 are used for horizontally connecting the blocks when the display screen is assembled into a panel. Slide fasteners are installed in a slide base and can be fastened with a wrench after being aligned with a fastener base. The fasteners 242 are used for horizontal connection when the display screen is assembled in an arch way. A pair of arc-shaped rings is respectively installed on an arc-shaped base, one equipped with a snap-fastener and the other equipped with a fastening pin. The arc between the two arc-shaped rings is not changed when the arc-shaped rings slide on the arc-shaped base. The pull rods are also equipped with a pair of rotary handles 26 for lifting the display screen blocks.

To assemble a panel-shaped display screen, align the U-shaped groove on the pull rod 22 with a plug or suspended beam of the pull rod 22 of a former display screen block, connect the two pull rods together with the plug, move the slide fastener to align slide fastener with the fastener base, pull the slide fastener to fasten the slide fastener along the arc-shaped groove of the fastener base. To assemble a shaped display screen, suspend the display screen block as mentioned above, loosen screws for fixing the arc-shaped rings before connecting the display screen blocks horizontally, adjust the distance between two arc-shaped rings to the optimal value, then fasten the screws for fixing the arc-shaped rings, and pull the snap-fastener to press the fastening pin.

The abovementioned is only a preferable embodiment of the present invention, which cannot limit the present invention. Within the technical spirit and principle of the present invention, subtle modifications, equivalent substitutions and improvements of the above embodiment all shall be incorporated in the protection scope of the present invention.

What is claimed is:

1. An LED display screen, wherein a display screen module consists of a small LED lamp, a printed circuit board, and electronic components, characterized in that, the display screen module is also equipped with a high power LED lamp to form a display screen light module; and the display screen light module is installed on a framework and plugged into a power distribution control box installed on the framework.

2. The display screen according to claim 1, characterized in that the display screen module is formed by welding the small LED lamp and electronic components on the printed circuit board and protected by a plastic housing.

3. The display screen according to claim 1, characterized in that the framework consists of left and right pull rods and a fixed frame; a reinforcing plate is disposed in the middle of the framework; the upper part of each of the pull rods is provided with a U-shaped groove, while the lower part is provided with a plug matched with the U-shaped groove; a latch for connecting the upper and lower pull rods is disposed next to each U-shaped groove, and thus two blocks can be quickly connected in the vertical direction.

4. The display screen according to claim 1, characterized in that the power distribution control box is made up of a metal bottom housing and a metal upper cover; the metal bottom housing is internally equipped with a drive power, a power output and signal transition plate and a signal output plate; a socket and a plug for quick connection of the power supply and signals are installed at two end of the metal bottom housing; and the metal upper cover is internally equipped with an adaptor plate.

5. The display screen according to claim 1, characterized in that the high power LED lamp is installed in the housing with a heat dissipation function, and the lamp is externally covered with a condensing hood.

6. The display screen according to claim 3, characterized in that the left and right pull rods of the framework are equipped with two groups of quick connectors for quick connection of left and right blocks, one used in the case that the display screen assembled into a panel and the other used in the case that modules are installed at an angle.

7. The displays screen according to claim 4, characterized in that the left and right pull rods of the framework are respectively equipped with a group of rotary handles for lifting the display screen.

8. The displays screen according to claim 4, characterized in that a waterproof rubber ring is located between the bottom housing and the upper cover and fastened with a screw.

9. The displays screen according to claim 4, characterized in that the DC power supply and signals of the drive power and the receiving card are transmitted to the adaptor plate by means of plugging.

10. The display screen according to claim 6, characterized in that the quick connector for assembling the display screen modules into a panel consists of a slide fastener and a fastener base; the slide fastener is installed in a fixed seat and is capable of sliding and rotating left and right; the slide fastener rotates 90° after being aligned with the fastener socket and then is fixed together with the fastener base; the quick connector for installing the blocks at an angle consists of a pair of arced rings and a pair of fasteners; the arced rings are installed on a bracket and are capable of sliding on the bracket to adjust distance there-between and also capable of keeping the same radian; the two arced rings are connected together with the fasteners after the distance is adjusted.
